(19) United States
(12) Patent Application Publication
(10) Pub. No.: US 2017/0301574 A1
(43) Pub. Date: Oct. 19, 2017

(54) RECIPE ID MANAGEMENT SERVER, RECIPE ID MANAGEMENT SYSTEM, AND TERMINAL DEVICE

(71) Applicant: Tokyo Electron Limited, Minato-ku, Tokyo (JP)

(72) Inventor: Mitsune SAKAMOTO, Minato-ku, Tokyo (JP)

(21) Appl. No.: 15/528,038

(22) PCT Filed: Nov. 6, 2015
(86) PCT No.: PCT/JP2015/081333

§ 371 Date: Jun. 6, 2017

(30) Foreign Application Priority Data
Nov. 19, 2014 (JP) 2014-234722

(51) Int. Cl. H01L 21/67; G06F 17/30; H04L 29/06

(52) U.S. Cl. CPC H01L 21/67294; H04L 63/083; G06F 17/30171; G06F 17/30197

(57) ABSTRACT

When receiving a partial ID request from a terminal device, a partial ID transmission unit reads out one or more partial IDs, of which each is a part of a recipe ID, from a partial ID storage unit and transmits the one or more partial IDs to the terminal device. A duplication determination unit determines whether the same recipe ID as a recipe ID created by the terminal device is stored in a recipe ID storage unit. When the same recipe ID as the recipe ID created by the terminal device is not stored in the recipe ID storage unit, an availability notification unit notifies the terminal device of usage permission of the recipe ID and causes the recipe ID storage unit to store the recipe ID created by the terminal device.

### FIELD

Various aspects and embodiments of the present invention relate to a recipe ID management server, a recipe ID management system, and a terminal device.

### BACKGROUND

An integrated circuit is manufactured by performing various processing steps on a substrate. Each processing step is executed under various processing conditions by using various processing apparatuses. A processing condition is referred to as a recipe. A recipe is a data set made by collectively programming settings and operation directives to be applied to a processing apparatus, for example. A recipe can be created or edited by a recipe editing function installed on a processing apparatus. A recipe can be also created or edited by a recipe editing function installed on a terminal device different from a processing apparatus. The recipe created or edited in the terminal device different from the processing apparatus is downloaded into the processing apparatus via a network and is executed by the processing apparatus. Herein, recipes are respectively identified by recipe IDs.

A product such as an integrated circuit is manufactured by way of many processing step. Recipes exist to the number of processing steps. If the type of a product is changed, the contents of a recipe are changed in many cases even in case of the same step. Moreover, even in case of the same product, a recipe may be changed by improvement, changing specification, or the like in some cases. For that reason, many recipes are generated by a combination of a product, a step, a version, and the like, and thus it is needed to apply correct recipes to respective processing steps. For example, there is known a technology that applies an appropriate recipe to a lot corresponding to a lot ID by indicating a recipe ID corresponding to the lot ID when the lot ID and the contents of its step are correct as production information (for example, see Patent Literature 1).

### CITATION LIST

### Patent Literature

Patent Literature 1: Japanese Laid-open Patent Publication No. 2012-133599

### SUMMARY

### Technical Problem

However, although each recipe is identified by its recipe ID, the same recipe ID may be given to recipes having different contents when recipe IDs are optionally given by a creator of the recipes. When the same recipe ID is given to recipes having different contents, a recipe having contents different from those of a recipe to be applied is applied to a processing step so as not to realize the intended process. Although it is considered to establish a naming rule of recipe IDs, the naming rule may not be observed by a creator of recipes. Moreover, even if the naming rule has been observed, the same recipe ID may be given to recipes having different contents due to the artificial error of a recipe creator.

### Solution to Problem

A recipe ID management server disclosed herein includes a partial ID storage unit, a recipe ID storage unit, a partial ID transmission unit, a duplication determination unit, and an availability notification unit. The partial ID storage unit stores therein one or more partial IDs of which each is a part of a recipe ID of identifying a recipe in which a process to be performed by a substrate processing apparatus is described, the one or more partial IDs being created in accordance with a predetermined naming rule. The recipe ID storage unit stores therein a recipe ID created by a terminal device that a user operates. The partial ID transmission unit reads out the one or more partial IDs from the partial ID storage unit and transmits the read one or more partial IDs to the terminal device when receiving a partial ID request from the terminal device. The duplication determination unit determines whether a same recipe ID is already stored in the recipe ID storage unit when receiving the recipe ID created by the terminal device. The availability notification unit notifies the terminal device of usage permission of the recipe ID created by the terminal device when the same recipe ID is not stored in the recipe ID storage unit and notifies the terminal device of usage non-permission of the recipe ID created by the terminal device when the same recipe ID is already stored in the recipe ID storage unit, and causes the recipe ID storage unit to store the recipe ID created by the terminal device.

### Advantageous Effects of Invention

According to one aspect of a recipe ID management server disclosed herein, to allocate the same recipe ID to recipes having different contents can be prevented.

### BRIEF DESCRIPTION OF DRAWINGS

FIG. 1 is a diagram illustrating an example of a recipe ID management system.

FIG. 2 is a block diagram illustrating an example of a recipe ID management server.

FIG. 3 is a diagram illustrating an example of data stored in a user information storage unit.

FIG. 4 is a diagram illustrating an example of data stored in an authority information storage unit.

FIG. 5 is a diagram illustrating an example of data stored in a partial ID storage unit.

FIG. 6 is a diagram illustrating an example of data stored in a recipe ID storage unit.

FIG. 7 is a block diagram illustrating an example of a terminal device.

FIG. 8 is a diagram illustrating an example of a creation process of a recipe ID.

FIG. 9 is a diagram illustrating an example of a reading process of a recipe.

FIG. 10 is a diagram illustrating an example of a copying process of the recipe.

FIG. 11 is a diagram illustrating an example of a deletion process of the recipe.

FIG. 12 is a diagram illustrating an example of an editing process of the recipe.

FIG. 13 is a diagram illustrating another example of the editing process of the recipe.

FIG. 14 is a diagram illustrating an example of a computer that realizes functions of the recipe ID management server or the terminal device.

### DESCRIPTION OF EMBODIMENT

A recipe ID management server according to one embodiment disclosed herein includes a partial ID storage unit, a recipe ID storage unit, a partial ID transmission unit, a duplication determination unit, and an availability notification unit. The partial ID storage unit stores therein one or more partial IDs of which each is a part of a recipe ID of identifying a recipe in which a process to be performed by a substrate processing apparatus is described, the one or more partial IDs being created in accordance with a predetermined naming rule. The recipe ID storage unit stores therein a recipe ID created by a terminal device that a user operates. The partial ID transmission unit reads out the one or more partial IDs from the partial ID storage unit and transmits the read one or more partial IDs to the terminal device when receiving a partial ID request from the terminal device. The duplication determination unit determines whether a same recipe ID is already stored in the recipe ID storage unit when receiving the recipe ID created by the terminal device. The availability notification unit notifies the terminal device of usage permission of the recipe ID created by the terminal device when the same recipe ID is not stored in the recipe ID storage unit and notifies the terminal device of usage non-permission of the recipe ID created by the terminal device when the same recipe ID is already stored in the recipe ID storage unit, and causes the recipe ID storage unit to store the recipe ID created by the terminal device.

In one embodiment of the recipe ID management server disclosed herein, the availability notification unit notifies the terminal device of usage non-permission of the recipe ID created by the terminal device when any one of the one or more partial IDs transmitted from the partial ID transmission unit is not included in the recipe ID created by the terminal device.

In one embodiment of the recipe ID management server disclosed herein, the recipe ID storage unit stores therein a lock flag in association with the recipe ID. The recipe ID management server according to one embodiment disclosed herein further includes an authority information storage unit, an editability determination unit, a lock determination unit, and a recipe management unit. The authority information storage unit stores, in association with each of user IDs of identifying each of users, therein authority information that indicates one or more operations permitted to the corresponding user with respect to recipes identified with respective recipe IDs. The editability determination unit determines, when receiving an editing request including a recipe ID and a user ID from the terminal device, whether editing of a recipe identified with the recipe ID included in the editing request is included in the authority information associated with the user ID included in the editing request as an operation permitted to a user identified with the user ID with reference to the authority information storage unit. The lock determination unit determines, when receiving the editing request including the recipe ID and the user ID from the terminal device, which of a lock state and an unlock state a lock flag associated with the recipe ID included in the editing request indicates with reference to the recipe ID storage unit. The recipe management unit notifies, when the editing of the recipe identified with the recipe ID included in the editing request is included as the operation permitted to the user identified with the user ID included in the editing request and the lock flag associated with the recipe ID included in the editing request indicates an unlock state, the terminal device of editing permission of the recipe identified with the recipe ID included in the editing request and changes the lock flag in the recipe ID storage unit into a lock state, and when the editing of the recipe in the lock state is terminated, returns to an unlock state the lock flag of the recipe of which editing is terminated.

The recipe ID management server according to one embodiment disclosed herein further includes a group information storage unit that stores, for each of the user IDs, therein a group ID of identifying a group to which a user identified with the corresponding user ID belongs. In one embodiment of the recipe ID management server disclosed herein, the partial ID storage unit further stores therein the group ID in association with the one or more partial IDs. The partial ID request includes a user ID. The partial ID transmission unit specifies, when receiving the partial ID request from the terminal device, a group ID associated with the user ID included in the partial ID request with reference to the group information storage unit, reads out a partial ID associated with the specified group ID from the partial ID storage unit, and transmits the read partial ID to the terminal device.

In one embodiment of the recipe ID management server disclosed herein, the partial ID includes at least one of information on a product to be manufactured by a process based on a recipe identified with a recipe ID including the partial ID and information on steps which use the recipe.

A recipe ID management system according to one embodiment disclosed herein includes a recipe ID management server that manages a recipe ID of identifying a recipe in which a process to be performed by a substrate processing apparatus is described and a terminal device that is operated by a user. The recipe ID management server includes a partial ID storage unit, a recipe ID storage unit, a partial ID transmission unit, a duplication determination unit, and an availability notification unit. The partial ID storage unit stores therein a partial ID that is a part of the recipe ID and is created in accordance with a predetermined naming rule. The recipe ID storage unit stores therein a recipe ID created by the terminal device. The partial ID transmission unit reads out the partial ID from the partial ID storage unit and transmits the read partial ID to the terminal device when receiving a partial ID request from the terminal device. The duplication determination unit determines whether a same recipe ID is already stored in the recipe ID storage unit when receiving the recipe ID created by the terminal device. The availability notification unit notifies the terminal device of usage permission of the recipe ID created by the terminal device when the same recipe ID is not stored in the recipe ID storage unit and notifies the terminal device of usage non-permission of the recipe ID created by the terminal device when the same recipe ID is already stored in the recipe ID storage unit, and causes the recipe ID storage unit to store the recipe ID created by the terminal device. The terminal device includes a partial ID requesting unit, a partial ID displaying unit, a recipe ID creating unit, and an availability displaying unit. The partial ID requesting unit transmits the partial ID request to the recipe ID management server in response to a request from the user. The partial ID displaying unit causes, when receiving the partial ID from the recipe ID management server, a display device to display the received partial ID. The recipe ID creating unit adds information received from the user to the partial ID received from the recipe ID management server to make a recipe ID and transmits the created recipe ID to the recipe ID management server. The availability displaying unit causes, when receiving from the recipe ID management server information that indicates whether the recipe ID created by the recipe ID creating unit is available, the display device to display the received information on availability.

A terminal device according to one embodiment disclosed herein includes a partial ID requesting unit, a partial ID displaying unit, a recipe ID creating unit, and an availability displaying unit. The partial ID requesting unit transmits a partial ID request to a recipe ID management server in response to a request from a user. The partial ID displaying unit causes, when receiving from the recipe ID management server a partial ID that is a part of a recipe ID of identifying a recipe in which a process to be performed by a substrate processing apparatus is described and that is created in accordance with a predetermined naming rule, a display device to display the received partial ID. The recipe ID creating unit adds information received from the user to the partial ID received from the recipe ID management server to make a recipe ID and transmits the created recipe ID to the recipe ID management server. The availability displaying unit causes, when receiving from the recipe ID management server information that indicates whether the recipe ID created by the recipe ID creating unit is available, the display device to display the received information on availability.

Exemplary embodiments of a recipe ID management server, a recipe ID management system, and a terminal device disclosed in the present application will be explained below in detail with reference to the accompanying drawings. The present invention is not limited to the embodiments explained below. The embodiments explained below may be appropriately combined within a scope in which the combined embodiments do not contradict each other.

### Embodiment

[Recipe ID Management System 10]

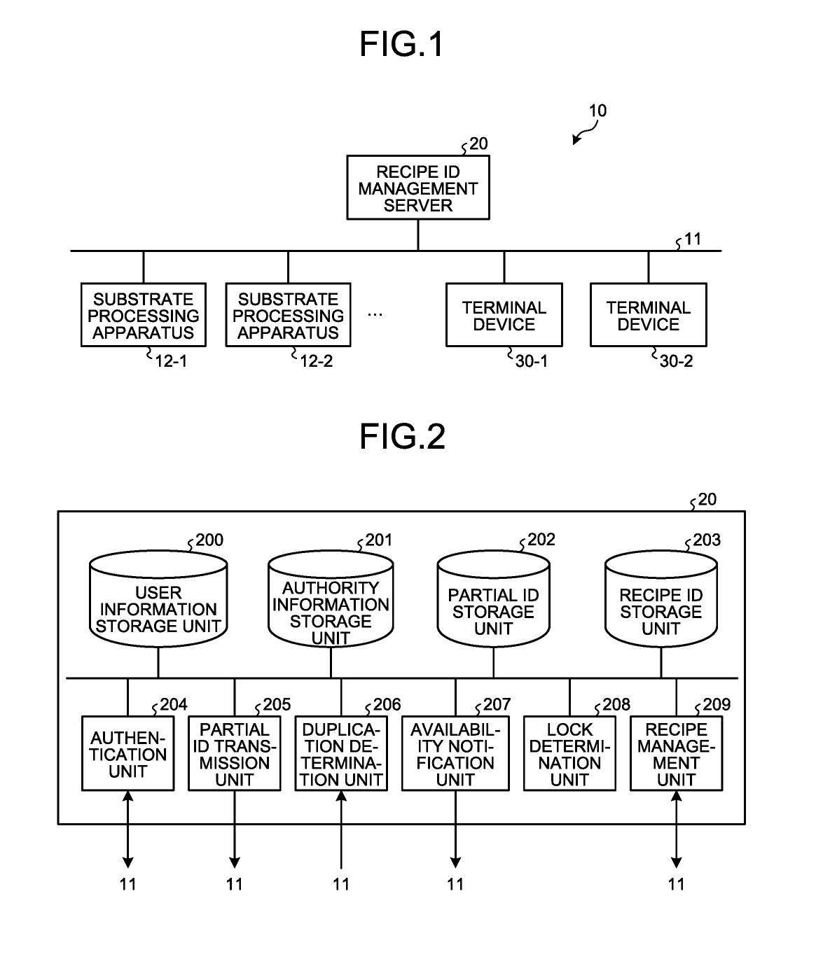

FIG. 1 is a diagram illustrating an example of a recipe ID management system 10. The recipe ID management system 10 according to the present embodiment includes a plurality of substrate processing apparatuses 12, a recipe ID management server 20, and a plurality of terminal devices 30. The substrate processing apparatuses 12, the recipe ID management server 20, and the terminal devices 30 are connected to a network 11 such as LAN.

Each of the substrate processing apparatuses 12 is an apparatus that performs processes such as film deposition, etching, and reforming on a substrate on the basis of the set recipe. In the present embodiment, a recipe is, for example, a data set made by collectively programming settings and operation directives to be applied to the substrate processing apparatus 12. The contents of recipes are different in accordance with the type of a product such as an integrated circuit, a lot, a processing step, the model of the substrate processing apparatus 12, or the like in many cases. For that reason, recipes are distinguished from one another in accordance with the type of a product to be applied, a lot, a processing step, the model of the substrate processing apparatus 12, or the like. Each recipe is identified with a recipe ID. A recipe ID is set as a file name of a file including data of a recipe, for example.

Each of the terminal devices 30 performs processes such as creating of a recipe ID, creating and editing of a recipe in response to an operation from a user. Each of the terminal devices 30 can be realized by a general-purpose computer for example. A recipe created by the terminal device 30 is downloaded into a memory in the substrate processing apparatus 12 via the network 11. Then, the substrate processing apparatus 12 performs processes on a substrate on the basis of the recipe stored in the memory. Similarly to each of the terminal devices 30, each of the substrate processing apparatuses 12 may be provided with functions for performing processes such as creating of a recipe ID, creating and editing of a recipe. In the following descriptions, the terminal device 30 may include a function part that is provided in the substrate processing apparatus 12 to perform processes such as creating of a recipe ID, creating and editing of a recipe.

The recipe ID management server 20 manages whether a recipe ID of a recipe created by each of the terminal devices 30 overlaps with recipe IDs registered already, and permits the use of the recipe ID when the recipe ID of the created recipe is unique. As a result, the recipe ID management server 20 prevents the same recipe ID from being assigned to recipes having different contents.

The recipe ID management server 20 manages copies of recipes, and permits assigning the same recipe ID to recipes having the same contents. When the contents of one recipe are changed among a plurality of recipes having the same contents and the same assigned recipe ID, the recipe ID management server 20 reflects the contents of the changed recipe on other recipes having the same assigned recipe ID or changes the recipe ID of the recipe having the changed contents to a different recipe ID. As a result, the recipe ID management server 20 prevents the same recipe ID from being assigned to recipes having different contents.

[Recipe ID Management Server 20]

FIG. 2 is a block diagram illustrating an example of the recipe ID management server 20. The recipe ID management server 20 includes a user information storage unit 200, an authority information storage unit 201, a partial ID storage unit 202, a recipe ID storage unit 203, an authentication unit 204, a partial ID transmission unit 205, a duplication determination unit 206, an availability notification unit 207, a lock determination unit 208, and a recipe management unit 209.

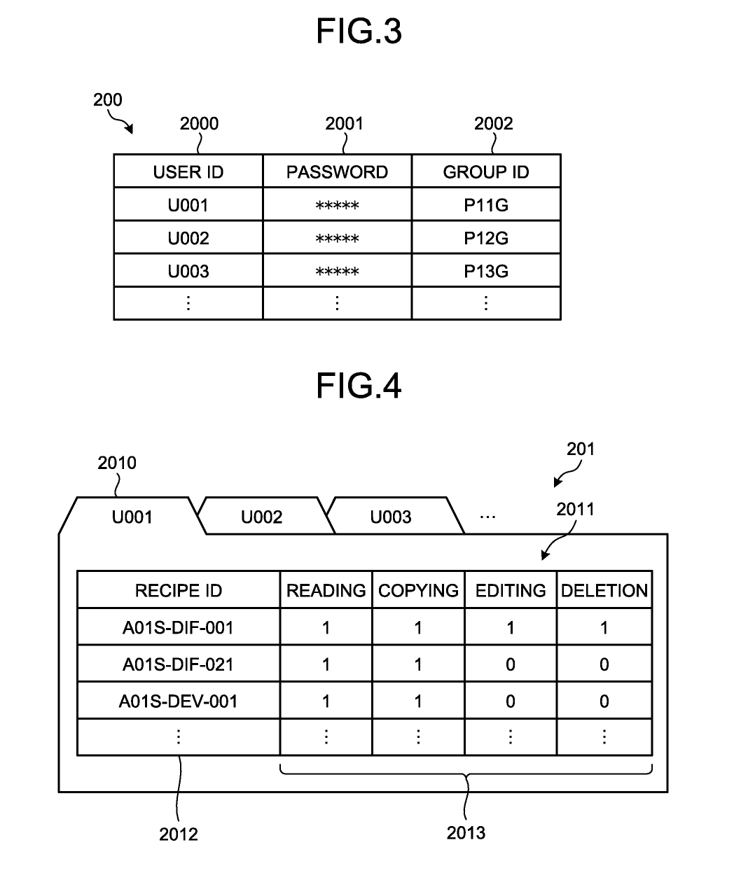

FIG. 3 is a diagram illustrating an example of data stored in the user information storage unit 200. For example, as illustrated in FIG. 3, the user information storage unit 200 stores therein a password 2001 and a group ID 2002 in association with a user ID 2000 of identifying each user. The group ID 2002 is identification information of a group to which a user identified with the user ID 2000 belongs.

In the present embodiment, assigned products and steps are classified under each group. For that reason, in accordance with which group a user belongs to, ranges of products and steps to be assigned to the user are different. Moreover, the ranges of products and steps to be assigned may partially overlap between groups. Moreover, information stored in the user information storage unit 200 is previously registered in the user information storage unit 200 by an administrator or the like of the recipe ID management system 10, for example.

FIG. 4 is a diagram illustrating an example of data stored in the authority information storage unit 201. For example, as illustrated in FIG. 4, the authority information storage unit 201 stores therein authority information tables 2011 in association with user IDs 2010. Authority information 2013 is stored in each of the authority information tables 2011 in association with a recipe ID 2012. The authority information 2013 includes information on operations permitted to a user identified with the user ID 2010 with respect to a recipe identified with the associated recipe ID 2012.

The operations with respect to a recipe include, for example, reading, copying, editing, and deletion of the recipe. In the authority information 2013 illustrated in FIG. 4, an operation permitted with respect to a recipe is associated with “1” for example, and an operation not permitted with respect to the recipe is associated with “0” for example. A part of information stored in the authority information storage unit 201 is registered by the recipe management unit 209. Moreover, information stored in the authority information storage unit 201 is registered by, for example, an administrator of the recipe ID management system 10.

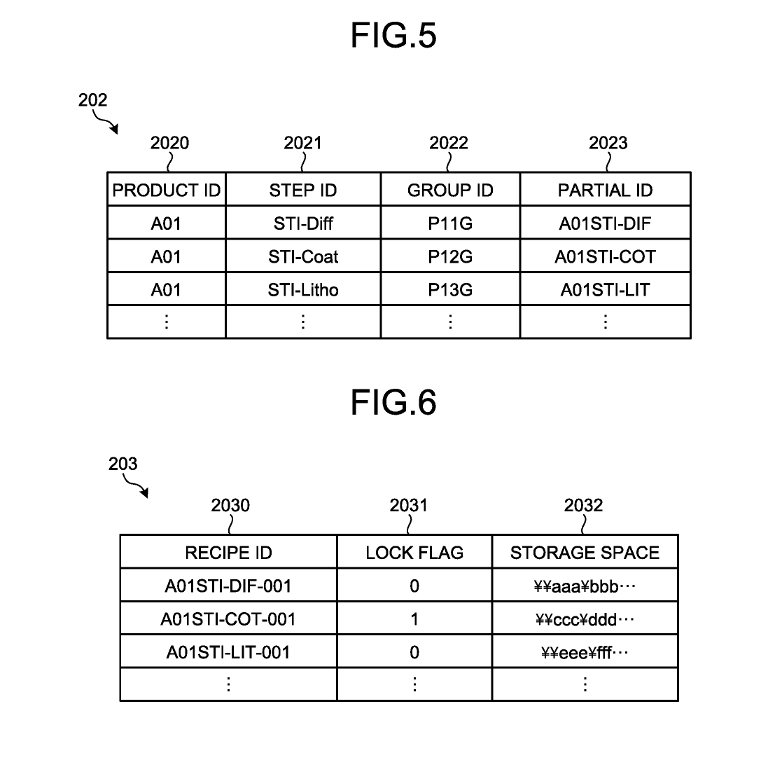

FIG. 5 is a diagram illustrating an example of data stored in the partial ID storage unit 202. For example, as illustrated in FIG. 5, the partial ID storage unit 202 stores therein a group ID 2022 and a partial ID 2023 in association with a combination of a product ID 2020 of identifying each product and a step ID 2021 of identifying each processing step. The partial ID 2023 is a part of information included in a recipe ID of a recipe to be applied to a product identified with the product ID 2020 in a processing step identified with the step ID 2021.

The partial ID 2023 is a part of a recipe ID created in accordance with a predetermined recipe-ID naming rule. A recipe-ID naming rule according to the present embodiment is, for example, a rule in which a recipe ID includes information on at least a part of the product ID 2020 and information on at least a part of the step ID 2021. The partial ID 2023 illustrated in FIG. 5 includes the product ID 2020 and a part of the step ID 2021. Information stored in the partial ID storage unit 202 is previously registered in the partial ID storage unit 202 by an administrator or the like of the recipe ID management system 10 for example.

FIG. 6 is a diagram illustrating an example of data stored in the recipe ID storage unit 203. For example, as illustrated in FIG. 6, the recipe ID storage unit 203 stores therein a lock flag 2031 and a storage space 2032 in association with a recipe ID 2030. When a recipe identified with the recipe ID 2030 is being edited, “1” that is a value indicating a lock state is registered in the lock flag 2031. When this recipe is not being edited, “0” that is a value indicating an unlock state is registered in the lock flag 2031. The storage space 2032 is information that indicates a space in which a recipe identified with the recipe ID 2030 is stored. When the recipe identified with the recipe ID 2030 is copied, the storage space 2032 stores information on a plurality of spaces.

Returning to FIG. 2, the explanations are continued. When receiving a first partial ID request including a user ID and a password from the terminal device 30 via the network 11, the authentication unit 204 extracts a password associated with the user ID included in the first partial ID request from the user information storage unit 200. Then, the authentication unit 204 determines whether the password extracted from the user information storage unit 200 is identical with the password included in the first partial ID request to authenticate a user of the terminal device 30 that has transmitted the first partial ID request.

When the authentication of the user is successful, the authentication unit 204 extracts a group ID associated with the user ID included in the first partial ID request from the user information storage unit 200. Then, the authentication unit 204 sends, to the partial ID transmission unit 205, the extracted group ID and information on the terminal device 30 that has transmitted the first partial ID request.

When receiving a reading request including a user ID, a password, and a recipe ID from the terminal device 30 via the network 11, the authentication unit 204 authenticates a user of the terminal device 30 that has transmitted the reading request on the basis of the user ID and the password included in the reading request with reference to the user information storage unit 200. When the authentication of the user is successful, the authentication unit 204 specifies the authority information table 2011 associated with the user ID included in the reading request among the authority information tables of the authority information storage unit 201. Then, the authentication unit 204 determines whether reading of a recipe identified with the recipe ID included in the reading request is permitted with reference to authority information in the specified authority information table 2011.

When reading of the recipe identified with the recipe ID included in the reading request is permitted, the authentication unit 204 extracts information on a storage space associated with the recipe ID included in the reading request from the recipe ID storage unit 203. When the number of storage spaces of the recipe ID is two or more, the authentication unit 204 may extract one of them or may extract all. Then, the authentication unit 204 transmits recipe information including the extracted information on the storage space(s) to the terminal device 30 that has transmitted the reading request.

When receiving a copying request including a user ID, a password, and a recipe ID from the terminal device 30 via the network 11, the authentication unit 204 authenticates a user of the terminal device 30 that has transmitted the copying request on the basis of the user ID and the password included in the copying request with reference to the user information storage unit 200. When the authentication of the user is successful, the authentication unit 204 specifies the authority information table 2011 associated with the user ID included in the copying request among the authority information tables of the authority information storage unit 201. Then, the authentication unit 204 determines whether copying of a recipe identified with the recipe ID included in the copying request is permitted with reference to authority information in the specified authority information table 2011.

When copying of the recipe identified with the recipe ID included in the copying request is permitted, the authentication unit 204 extracts information on a storage space associated with the recipe ID included in the copying request from the recipe ID storage unit 203. Then, the authentication unit 204 transmits recipe information including the extracted information on the storage space to the terminal device 30 that has transmitted the copying request.

When receiving a deletion request including a user ID, a password, and a recipe ID from the terminal device 30 via the network 11, the authentication unit 204 authenticates a user of the terminal device 30 that has transmitted the deletion request on the basis of the user ID and the password included in the deletion request with reference to the user information storage unit 200. When the authentication of the user is successful, the authentication unit 204 specifies the authority information table 2011 associated with the user ID included in the deletion request among the authority information tables of the authority information storage unit 201. Then, the authentication unit 204 determines whether deletion of a recipe identified with the recipe ID included in the deletion request is permitted with reference to authority information in the specified authority information table 2011.

When deletion of the recipe identified with the recipe ID included in the deletion request is permitted, the authentication unit 204 extracts information on a storage space associated with the recipe ID included in the deletion request from the recipe ID storage unit 203. Then, the authentication unit 204 transmits recipe information including the extracted information on the storage space to the terminal device 30 that has transmitted the deletion request.

When receiving an editing request including a user ID, a password, and a recipe ID from the terminal device 30 via the network 11, the authentication unit 204 authenticates a user of the terminal device 30 that has transmitted the editing request on the basis of the user ID and the password included in the editing request with reference to the user information storage unit 200. When the authentication of the user is successful, the authentication unit 204 specifies the authority information table 2011 associated with the user ID included in the editing request among the authority information tables of the authority information storage unit 201. Then, the authentication unit 204 determines whether editing of a recipe identified with the recipe ID included in the editing request is permitted with reference to authority information in the specified authority information table 2011. When editing of the recipe identified with the recipe ID included in the editing request is permitted, the authentication unit 204 sends, to the lock determination unit 208, the recipe ID included in the editing request and information on the terminal device 30 that has transmitted the editing request.

When receiving a group ID from the authentication unit 204 or the recipe management unit 209, the partial ID transmission unit 205 extracts a partial ID associated with the group ID from the partial ID storage unit 202. The partial ID transmission unit 205 extracts a plurality of partial IDs from the partial ID storage unit 202 when two or more partial IDs associated with the group ID are in the partial ID storage unit 202.

Then, the partial ID transmission unit 205 extracts a recipe ID including the partial ID extracted from the partial ID storage unit 202 from the recipe ID storage unit 203. When the group ID is received from the authentication unit 204, the partial ID transmission unit 205 transmits partial-ID notification including the partial ID extracted from the partial ID storage unit 202 and the recipe ID extracted from the recipe ID storage unit 203 to the terminal device 30 that has transmitted the first partial ID request. On the other hand, when the group ID is received from the recipe management unit 209, the partial ID transmission unit 205 transmits partial-ID notification including the partial ID extracted from the partial ID storage unit 202 and the recipe ID extracted from the recipe ID storage unit 203 to the terminal device 30 that has transmitted a second partial ID request to be described later. Then, the partial ID transmission unit 205 sends the partial ID extracted from the partial ID storage unit 202 to the duplication determination unit 206.

When receiving a determination request including a recipe ID from the terminal device 30, the duplication determination unit 206 determines, with reference to the recipe ID storage unit 203, whether any one of the partial IDs received from the partial ID transmission unit 205 is included in the recipe ID included in the determination request and whether the same recipe ID as the recipe ID included in the determination request is already stored in the recipe ID storage unit 203. Then, the duplication determination unit 206 sends the determination result to the availability notification unit 207.

When the duplication determination unit 206 determines that any one of the partial IDs received from the partial ID transmission unit 205 is not included in the recipe ID included in the determination request, or when the duplication determination unit 206 determines that the same recipe ID as the recipe ID included in the determination request is already stored in the recipe ID storage unit 203, the availability notification unit 207 transmits determination notification including information indicative of usage non-permission of the recipe ID to the terminal device 30 that has transmitted the determination request. As a result, the availability notification unit 207 can prevent the use of a recipe including a partial ID not according to a predetermined recipe-ID naming rule and can prevent the use of a recipe ID overlapping with recipe IDs that are already used.

On the other hand, when the duplication determination unit 206 determines that any one of the partial IDs received from the partial ID transmission unit 205 is included in the recipe ID included in the determination request and that the same recipe ID as the recipe ID included in the determination request is not stored in the recipe ID storage unit 203, the availability notification unit 207 transmits determination notification including the recipe ID and usage permission information to the terminal device 30 that has transmitted the determination request. Then, the availability notification unit 207 causes the recipe ID storage unit 203 to store the recipe ID included in the determination request. At this time, “0” indicating a unlock state is stored in the lock flag associated with the recipe ID, and its storage space becomes blank.

When receiving from the authentication unit 204 the recipe ID included in the editing request and the information on the terminal device 30 that has transmitted the editing request, the lock determination unit 208 determines whether a value of a lock flag associated with the recipe ID is a value indicating a lock state or a value indicating a unlock state with reference to the recipe ID storage unit 203. When the value of the lock flag is a value indicating a lock state, the lock determination unit 208 transmits error notification including information indicating a locked state to the terminal device 30 that has transmitted the editing request. On the other hand, when the value of the lock flag is a value indicating a unlock state, the lock determination unit 208 sends the recipe ID included in the editing request to the recipe management unit 209.

When receiving creating-completion notification including a recipe ID, information indicating the storage space of a recipe, and a user ID from the terminal device 30, the recipe management unit 209 specifies the recipe ID included in the creating-completion notification among the recipe IDs of the recipe ID storage unit 203. Then, the recipe management unit 209 registers information indicating the storage space included in the creating-completion notification in the recipe ID storage unit 203 in association with the specified recipe ID.

Then, the recipe management unit 209 specifies an authority information table associated with the user ID included in the creating-completion notification among the authority information tables of the authority information storage unit 201. Then, the recipe management unit 209 registers the recipe ID included in the creating-completion notification in the specified authority information table, and associates the recipe ID with authority information indicating that, for example, all operations are permitted with respect to a recipe identified with the recipe ID.

When receiving copying-completion notification including a recipe ID and information indicating the storage space of a copied recipe from the terminal device 30, the recipe management unit 209 specifies the recipe ID included in the copying-completion notification among the recipe IDs of the recipe ID storage unit 203. Then, the recipe management unit 209 adds the information indicating the storage space included in the copying-completion notification to information indicating the storage space associated with the specified recipe ID.

When receiving from the terminal device 30 deletion-completion notification including a recipe ID and information indicating a space in which the deleted recipe is stored, the recipe management unit 209 specifies the recipe ID included in the deletion-completion notification among the recipe IDs of the recipe ID storage unit 203. Then, the recipe management unit 209 deletes the information indicating the space included in the deletion-completion notification from information indicating the storage space associated with the specified recipe ID. Moreover, when the storage space associated with the recipe ID is only the information on the space included in the deletion-completion notification, the recipe management unit 209 deletes an entry including the recipe ID included in the deletion-completion notification from the recipe ID storage unit 203.

When receiving the recipe ID of the recipe of which editing is permitted from the lock determination unit 208, the recipe management unit 209 extracts information indicating a storage space associated with the recipe ID from the recipe ID storage unit 203. Then, the recipe management unit 209 transmits editing permission including the extracted information indicating the storage space to the terminal device 30 that has transmitted the editing request. Then, the recipe management unit 209 changes a value of a lock flag associated with the recipe ID received from the lock determination unit 208 into a value indicating a lock state with reference to the recipe ID storage unit 203.

When receiving editing-completion notification including a recipe ID and information indicating a storage space from the terminal device 30, the recipe management unit 209 specifies the recipe ID included in the editing-completion notification among the recipe IDs of the recipe ID storage unit 203. Then, the recipe management unit 209 returns a value of a lock flag associated with the specified recipe ID into a value indicating a unlock state.

Then, when information on a space other than the storage space included in the editing-completion notification is included in information on a storage space associated with the specified recipe ID, the recipe management unit 209 acquires a recipe after editing from the space specified with the information on the storage space included in the editing-completion notification. Then, the recipe management unit 209 overwrites, with the acquired recipe, another recipe to which the same recipe ID as the recipe ID included in the editing-completion notification is assigned. As a result, when one of recipes to which the same recipe ID is assigned is edited, the recipe management unit 209 can change the contents of remaining recipes to which the same recipe ID is assigned into the same contents as those of the edited recipe. Therefore, the recipe management unit 209 can prevent the same recipe ID from being assigned to recipes having different contents.

When receiving a second partial ID request including a recipe ID of a recipe before editing and a user ID, the recipe management unit 209 specifies the recipe ID included in the second partial ID request among the recipe IDs of the recipe ID storage unit 203. Then, the recipe management unit 209 returns a value of a lock flag associated with the specified recipe ID to a value indicating a unlock state. Then, the recipe management unit 209 specifies a group ID associated with the user ID included in the second partial ID request with reference to the user information storage unit 200. Then, the recipe management unit 209 sends, to the partial ID transmission unit 205, the specified group ID and information on the terminal device 30 that has transmitted the second partial ID request.

When receiving storage-completion notification including a recipe ID, information indicating a storage space of a recipe, and a user ID, the recipe management unit 209 registers the recipe ID included in the storage-completion notification in the recipe ID storage unit 203. Then, the recipe management unit 209 sets a value indicating a unlock state in a lock flag associated with the recipe ID, and registers the information on the storage space included in the storage-completion notification in information on a storage space associated with the recipe ID.

Then, the recipe management unit 209 specifies an authority information table associated with the user ID included in the storage-completion notification among the authority information tables of the authority information storage unit 201. Then, the recipe management unit 209 registers the recipe ID included in the storage-completion notification in the specified authority information table, and associates the recipe ID with authority information indicating that, for example, all operations are permitted with respect to a recipe identified with the recipe ID.

[Terminal Device 30]

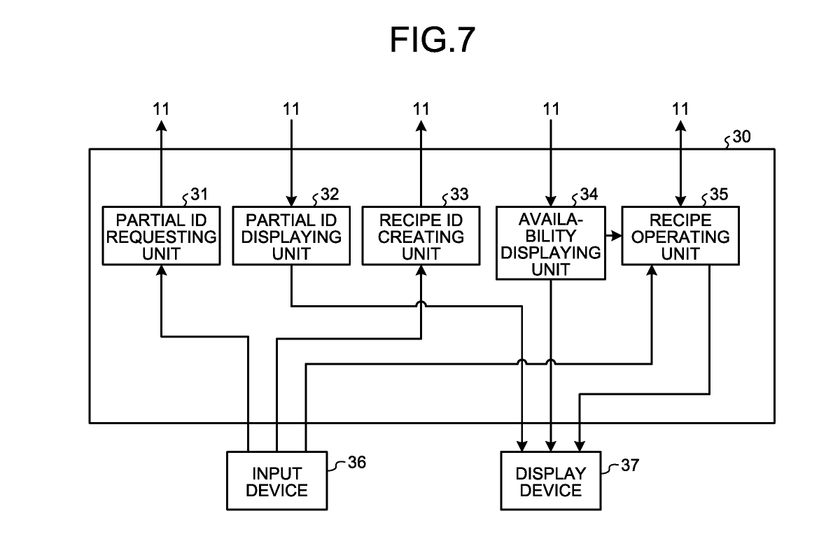

FIG. 7 is a block diagram illustrating an example of the terminal device 30. For example, as illustrated in FIG. 7, the terminal device 30 according to the present embodiment includes a partial ID requesting unit 31, a partial ID displaying unit 32, a recipe ID creating unit 33, an availability displaying unit 34, and a recipe operating unit 35.

The partial ID requesting unit 31 creates a first partial ID request including the user ID and password of a user in response to the operation of the user through an input device 36 such as a keyboard and a mouse. Then, the partial ID requesting unit 31 transmits the created first partial ID request to the recipe ID management server 20 via the network 11.

When receiving partial-ID notification including a partial ID and an already-registered recipe ID from the recipe ID management server 20 via the network 11, the partial ID displaying unit 32 causes a display device 37 such as a liquid crystal display to display the received partial ID and already-registered recipe ID. As a result, the terminal device 30 can create a recipe ID that is according to a predetermined recipe-ID naming rule and does not overlap with any of recipe IDs that are already used. The user can easily create a recipe ID that includes the displayed partial ID and is different from the already-registered recipe IDs.

The recipe ID creating unit 33 adds at least one of characters, symbols, numbers, and the like input from the user to the partial ID received from the recipe ID management server 20 to create a recipe ID in response to an operation from the user through the input device 36. Then, the recipe ID creating unit 33 creates a determination request including the created recipe ID, and transmits the created determination request to the recipe ID management server 20 via the network 11.

When receiving determination notification from the recipe ID management server 20 via the network 11, the availability displaying unit 34 causes the display device 37 to display the contents of the determination notification. When the use of the created recipe ID is permitted, the determination notification includes usage permission information and the recipe ID of which the use is permitted. When the determination notification includes the usage permission information and the recipe ID of which the use is permitted, the availability displaying unit 34 sends the recipe ID of which the use is permitted to the recipe operating unit 35.

The recipe operating unit 35 performs an operation of reading, copying, deletion, or editing on a recipe in response to an operation from the user through the input device 36. When receiving the recipe ID of which the use is permitted from the availability displaying unit 34, the recipe operating unit 35 starts creating a recipe identified with the recipe ID. Then, the recipe operating unit 35 terminates the creation of the recipe in response to an operation from the user through the input device 36, and transmits to the recipe ID management server 20 the creating-completion notification including the recipe ID of the created recipe, information on the storage space of the created recipe, and the user ID of the user when the created recipe is stored.

When receiving a recipe reading indication from the user via the input device 36, the recipe operating unit 35 creates a reading request including the recipe ID of a recipe to be read and the user ID and password of the user, and transmits the created reading request to the recipe ID management server 20 via the network 11. Then, when receiving recipe information from the recipe ID management server 20, the recipe operating unit 35 acquires the recipe to be read from a space specified with information on the storage space included in the recipe information, and causes the display device 37 to display the acquired recipe.

When receiving a recipe copying indication from the user via the input device 36, the recipe operating unit 35 creates a copying request including the recipe ID of a recipe to be copied and the user ID and password of the user, and transmits the created copying request to the recipe ID management server 20 via the network 11. Then, when receiving recipe information from the recipe ID management server 20, the recipe operating unit 35 acquires the recipe to be copied from a space specified with information on the storage space included in the recipe information. Then, the recipe operating unit 35 creates a copy of the acquired recipe, and stores the created copy of the recipe in the space indicated by the user. Then, the recipe operating unit 35 creates copying-completion notification including the recipe ID of the copied recipe and information indicating the storage space of the copied recipe, and transmits the created copying-completion notification to the recipe ID management server 20 via the network 11.

When receiving a recipe deletion indication from the user via the input device 36, the recipe operating unit 35 creates a deletion request including the recipe ID of a recipe to be deleted and the user ID and password of the user, and transmits the created deletion request to the recipe ID management server 20 via the network 11. Then, when receiving recipe information from the recipe ID management server 20, the recipe operating unit 35 deletes the recipe to be deleted from a space specified with information on the storage space included in the recipe information. Then, the recipe operating unit 35 creates deletion-completion notification including the recipe ID of the deleted recipe and the information indicating the space in which the deleted recipe has been stored, and transmits the created deletion-completion notification to the recipe ID management server 20 via the network 11.

When receiving a recipe editing indication from the user via the input device 36, the recipe operating unit 35 creates an editing request including the recipe ID of a recipe to be edited and the user ID and password of the user, and transmits the created editing request to the recipe ID management server 20 via the network 11. Then, when receiving editing permission from the recipe ID management server 20, the recipe operating unit 35 acquires a recipe to be edited from a space specified with information on the storage space included in the editing permission. The recipe operating unit 35 then causes the display device 37 to display the acquired recipe, and starts editing the acquired recipe.

Then, when the editing of the recipe is terminated in response to an operation from the user through the input device 36, the recipe operating unit 35 inquires of the user the storage method of the edited recipe. In the present embodiment, the storage method of the edited recipe includes, for example, a method in which the recipe before editing is overwritten with the edited recipe to store the edited recipe and a method in which another recipe ID is assigned to the edited recipe to store the edited recipe as another recipe.

When overwriting the edited recipe, the recipe operating unit 35 overwrites with the edited recipe the recipe stored in the space specified with information on the storage space included in the editing permission and stores the overwritten recipe. Then, the recipe operating unit 35 creates editing-completion notification including the recipe ID of the edited recipe and the information on the storage space of the overwritten recipe, and transmits the created editing-completion notification to the recipe ID management server 20 via the network 11.

On the other hand, when another recipe ID is assigned to the edited recipe to store the edited recipe, the recipe operating unit 35 creates a second partial ID request including a user ID of the user and a recipe ID of the recipe before editing, and transmits the created second partial ID request to the recipe ID management server 20 via the network 11. Then, when receiving a recipe ID of which the use is permitted from the availability displaying unit 34, the recipe operating unit 35 assigns the recipe ID received from the availability displaying unit 34 to the edited recipe to store the edited recipe. Then, the recipe operating unit 35 creates storage-completion notification including the information indicating the storage space of the edited recipe and the recipe ID assigned to the edited recipe, and transmits the created storage-completion notification to the recipe ID management server 20 via the network 11.

[Creating Process of Recipe ID]

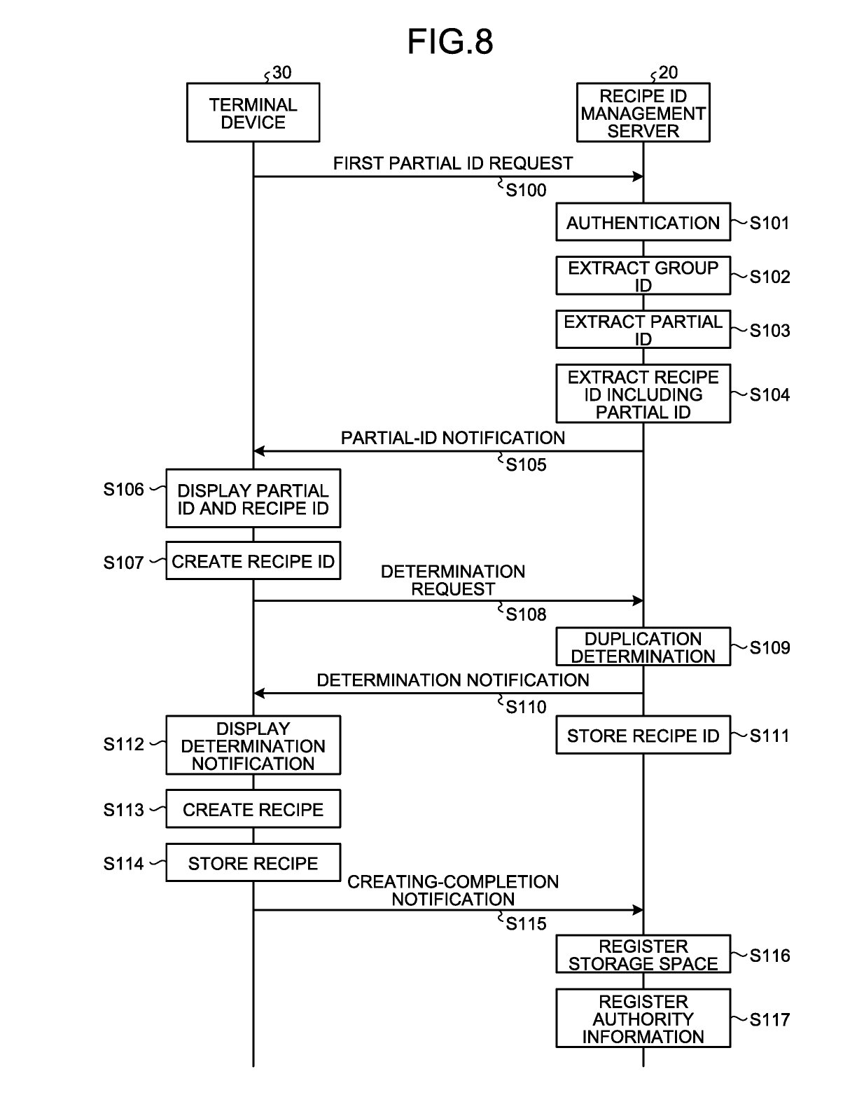

FIG. 8 is a diagram illustrating an example of a creating process of a recipe ID. First, the partial ID requesting unit 31 of the terminal device 30 creates a first partial ID request including the user ID and password of a user and transmits the created first partial ID request to the recipe ID management server 20 in response to an operation of the user through the input device 36 (S100).

The authentication unit 204 of the recipe ID management server 20 authenticates the user of the terminal device 30 that has transmitted the first partial ID request on the basis of the user ID and the password included in the first partial ID request with reference to the user information storage unit 200 (S101). When the authentication of the user is successful, the authentication unit 204 extracts a group ID associated with the user ID included in the first partial ID request from the user information storage unit 200 (S102). Then, the authentication unit 204 sends the extracted group ID to the partial ID transmission unit 205. On the other hand, when the authentication of the user is unsuccessful, the authentication unit 204 transmits error notification including information indicating authentication failure to the terminal device 30 that has transmitted the first partial ID request.

Next, the partial ID transmission unit 205 extracts a partial ID associated with the group ID received from the authentication unit 204 from the partial ID storage unit 202 (S103). Then, the partial ID transmission unit 205 extracts a recipe ID including the partial ID extracted from the partial ID storage unit 202 from the recipe ID storage unit 203 (S104). Then, the partial ID transmission unit 205 transmits partial-ID notification, which includes the partial ID extracted from the partial ID storage unit 202 and the recipe ID extracted from the recipe ID storage unit 203, to the terminal device 30 that has transmitted the first partial ID request (S105).

The partial ID displaying unit 32 of the terminal device 30 causes the display device 37 to display the partial ID and the recipe ID included in the partial-ID notification received from the recipe ID management server 20 (S106). Then, the recipe ID creating unit 33 adds a character, a symbol, a number, or the like input from the user to the partial ID received from the recipe ID management server 20 to create a recipe ID in response to an operation from the user through the input device 36 (S107). Then, the recipe ID creating unit 33 creates a determination request including the created recipe ID, and transmits the created determination request to the recipe ID management server 20 (S108).

The duplication determination unit 206 of the recipe ID management server 20 performs, with reference to the recipe ID storage unit 203, duplication determination for determining whether any one of partial IDs received from the partial ID transmission unit 205 is included in the recipe ID included in the determination request and whether the same recipe ID as the recipe ID included in the determination request is already stored in the recipe ID storage unit 203 (S109). Then, the duplication determination unit 206 sends the determination result to the availability notification unit 207.

Next, when the duplication determination unit 206 determines that any one of the partial IDs received from the partial ID transmission unit 205 is included in the recipe ID included in the determination request and that the same recipe ID as the recipe ID included in the determination request is not stored in the recipe ID storage unit 203, the availability notification unit 207 transmits determination notification including the recipe ID and usage permission information to the terminal device 30 that has transmitted the determination request (S110). Then, the availability notification unit 207 causes the recipe ID storage unit 203 to store the recipe ID included in the determination request (S111).

When the duplication determination unit 206 determines that any one of the partial IDs received from the partial ID transmission unit 205 is not included in the recipe ID included in the determination request or that the same recipe ID as the recipe ID included in the determination request is already stored in the recipe ID storage unit 203, the availability notification unit 207 transmits determination notification including information indicating usage non-permission of the recipe ID to the terminal device 30 that has transmitted the determination request.

The availability displaying unit 34 of the terminal device 30 causes the display device 37 to display the contents of the determination notification received from the terminal device 30 (S112). When the determination notification includes usage permission information and the recipe ID of which the use is permitted, the availability displaying unit 34 sends the recipe ID of which the use is permitted to the recipe operating unit 35. The recipe operating unit 35 starts creating a recipe identified with the recipe ID received from the availability displaying unit 34 (S113).

Then, when the creation of the recipe is terminated in response to an operation from the user through the input device 36, the recipe operating unit 35 stores the created recipe (S114). Then, the recipe operating unit 35 creates creating-completion notification including the recipe ID of the created recipe, information on the storage space of the created recipe, and the user ID of the user, and transmits the created creating-completion notification to the recipe ID management server 20 (S115).

The recipe management unit 209 of the recipe ID management server 20 specifies the recipe ID included in the creating-completion notification received from the terminal device 30 among the recipe IDs of the recipe ID storage unit 203. Then, the recipe management unit 209 registers the information indicating the storage space included in the creating-completion notification in the recipe ID storage unit 203 in association with the specified recipe ID (S116).

Next, the recipe management unit 209 specifies an authority information table associated with the user ID included in the creating-completion notification among the authority information tables of the authority information storage unit 201. Then, the recipe management unit 209 registers the recipe ID included in the creating-completion notification in the specified authority information table, and also associates the recipe ID with authority information indicating that, for example, all operations are permitted with respect to the recipe identified with the recipe ID (S117).

[Reading Process of Recipe]

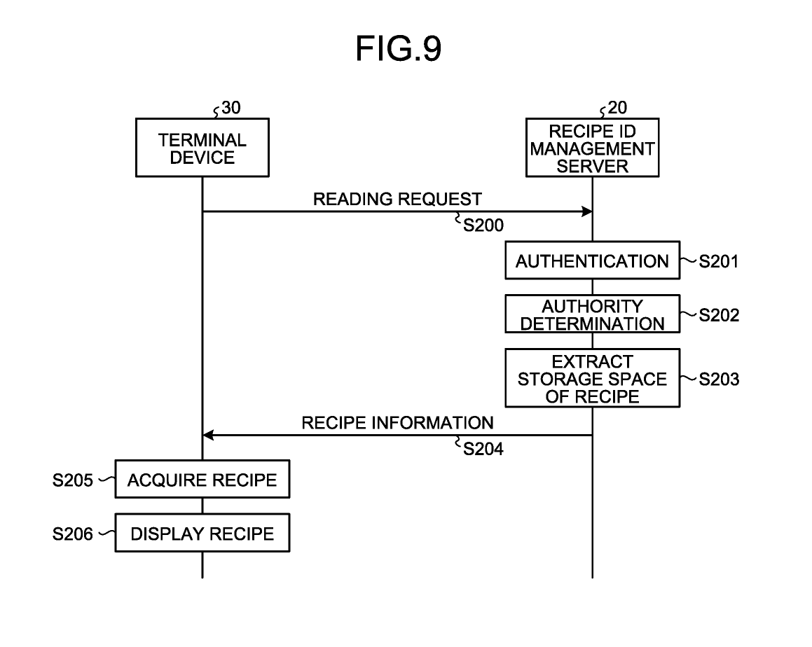

FIG. 9 is a diagram illustrating an example of a reading process of a recipe. First, the recipe operating unit 35 of the terminal device 30 creates a reading request including the user ID and password of a user and the recipe ID of a recipe to be read and transmits the created reading request to the recipe ID management server 20 in response to a reading directive from the user through the input device 36 (S200).

The authentication unit 204 of the recipe ID management server 20 authenticates the user of the terminal device 30 that has transmitted the reading request on the basis of the user ID and the password included in the reading request received from the terminal device 30 with reference to the user information storage unit 200 (S201). When the authentication of the user is successful, the authentication unit 204 specifies the authority information table 2011 associated with the user ID included in the reading request among the authority information tables of the authority information storage unit 201. Then, the authentication unit 204 determines whether reading of the recipe identified with the recipe ID included in the reading request is permitted with reference to the authority information in the specified authority information table 2011 (S202).

When reading of the recipe identified with the recipe ID included in the reading request is permitted, the authentication unit 204 extracts information on the storage space associated with the recipe ID included in the reading request from the recipe ID storage unit 203 (S203). Then, the authentication unit 204 transmits recipe information including the extracted information on the storage space to the terminal device 30 that has transmitted the reading request (S204). On the other hand, when reading of the recipe identified with the recipe ID included in the reading request is not permitted, the authentication unit 204 transmits error notification including information indicating that there is not reading authority to the terminal device 30 that has transmitted the reading request.

The recipe operating unit 35 of the terminal device 30 acquires the recipe to be read from a space specified with the information on the storage space included in the recipe information received from the recipe ID management server 20 (S205). The recipe operating unit 35 then causes the display device 37 to display the acquired recipe (S206).

[Copying Process of Recipe]

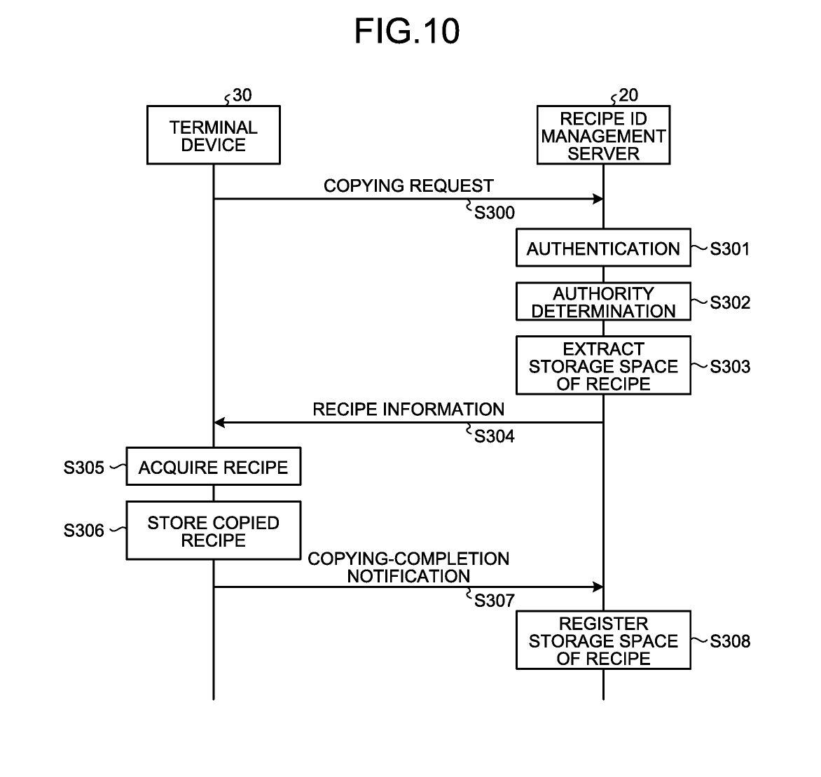

FIG. 10 is a diagram illustrating an example of a copying process of a recipe. First, the recipe operating unit 35 of the terminal device 30 creates a copying request including the user ID and password of a user and the recipe ID of a recipe to be copied and transmits the created copying request to the recipe ID management server 20 in response to a copying directive from the user through the input device 36 (S300).

The authentication unit 204 of the recipe ID management server 20 authenticates the user of the terminal device 30 that has transmitted the copying request on the basis of the user ID and the password included in the copying request received from the terminal device 30 with reference to the user information storage unit 200 (S301). When the authentication of the user is successful, the authentication unit 204 specifies the authority information table 2011 associated with the user ID included in the copying request among the authority information tables of the authority information storage unit 201. Then, the authentication unit 204 determines whether copying of a recipe identified with the recipe ID included in the copying request is permitted with reference to authority information in the specified authority information table 2011 (S302).

When copying of the recipe identified with the recipe ID included in the copying request is permitted, the authentication unit 204 extracts information on the storage space associated with the recipe ID included in the copying request from the recipe ID storage unit 203 (S303). Then, the authentication unit 204 transmits recipe information including the extracted information on the storage space to the terminal device 30 that has transmitted the copying request (S304). On the other hand, when copying of the recipe identified with the recipe ID included in the copying request is not permitted, the authentication unit 204 transmits error notification including information indicating that there is not copying authority to the terminal device 30 that has transmitted the copying request.

The recipe operating unit 35 of the terminal device 30 acquires the recipe to be copied from a space specified with the information on the storage space included in the recipe information received from the recipe ID management server 20 (S305). Then, the recipe operating unit 35 creates a copy of the acquired recipe and stores the copy of the created recipe in the space indicated by the user (S306). Then, the recipe operating unit 35 creates copying-completion notification including the recipe ID of the copied recipe and information indicating the storage space of the copied recipe, and transmits the created copying-completion notification to the recipe ID management server 20 (S307).

The recipe management unit 209 of the recipe ID management server 20 specifies the recipe ID included in the copying-completion notification received from the terminal device 30 among the recipe IDs of the recipe ID storage unit 203. Then, the recipe management unit 209 additionally registers the information indicating the storage space included in the copying-completion notification in the information indicating the storage space associated with the specified recipe ID (S308).

[Deletion Process of Recipe]

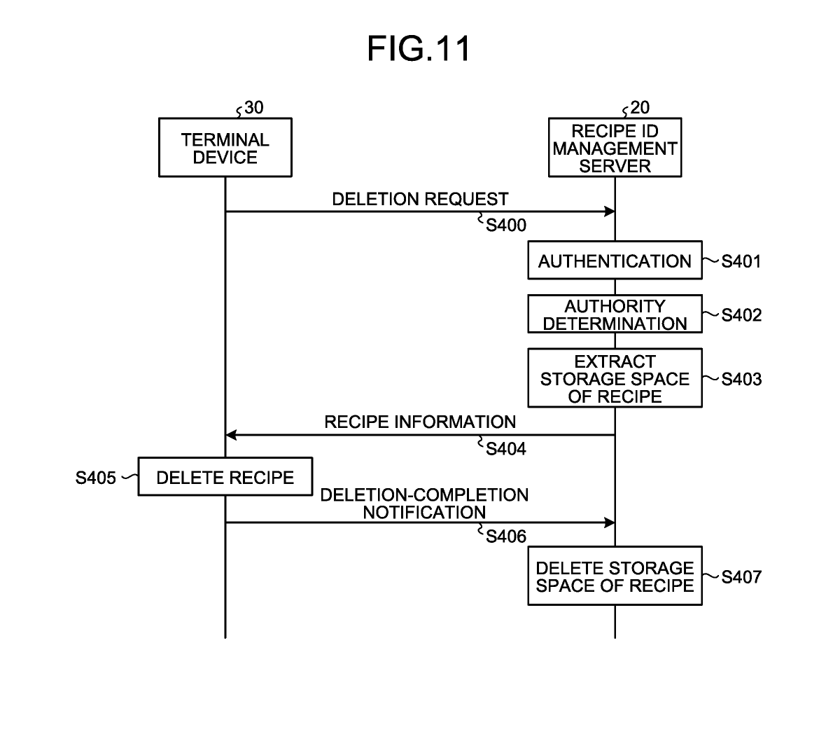

FIG. 11 is a diagram illustrating an example of a deletion process of a recipe. First, the recipe operating unit 35 of the terminal device 30 creates a deletion request including the user ID and password of a user and the recipe ID of a recipe to be deleted and transmits the created deletion request to the recipe ID management server 20 in response to a deletion directive from the user through the input device 36 (S400).

The authentication unit 204 of the recipe ID management server 20 authenticates the user of the terminal device 30 that has transmitted the deletion request on the basis of the user ID and the password included in the deletion request received from the terminal device 30 with reference to the user information storage unit 200 (S401). When the authentication of the user is successful, the authentication unit 204 specifies the authority information table 2011 associated with the user ID included in the deletion request among the authority information tables of the authority information storage unit 201. Then, the authentication unit 204 determines whether deletion of a recipe identified with the recipe ID included in the deletion request is permitted with reference to the authority information in the specified authority information table 2011 (S402).

When deletion of the recipe identified with the recipe ID included in the deletion request is permitted, the authentication unit 204 extracts information on the storage space associated with the recipe ID included in the deletion request from the recipe ID storage unit 203 (S403). Then, the authentication unit 204 transmits recipe information including the extracted information on the storage space to the terminal device 30 that has transmitted the deletion request (S404). On the other hand, when deletion of the recipe identified with the recipe ID included in the deletion request is not permitted, the authentication unit 204 transmits error notification including information indicating that there is not deletion authority to the terminal device 30 that has transmitted the deletion request.

The recipe operating unit 35 of the terminal device 30 deletes a recipe to be deleted from a space specified with the information on the storage space included in the recipe information received from the recipe ID management server 20 (S405). Then, the recipe operating unit 35 creates deletion-completion notification including the recipe ID of the deleted recipe and information indicating the space in which the deleted recipe has been stored, and transmits the created deletion-completion notification to the recipe ID management server 20 (S406).

The recipe management unit 209 of the recipe ID management server 20 specifies the recipe ID included in the deletion-completion notification received from the terminal device 30 among the recipe IDs of the recipe ID storage unit 203. Then, the recipe management unit 209 deletes the information indicating the space included in the deletion-completion notification from the information indicating the storage space associated with the specified recipe ID (S407).

[Editing Process of Recipe]

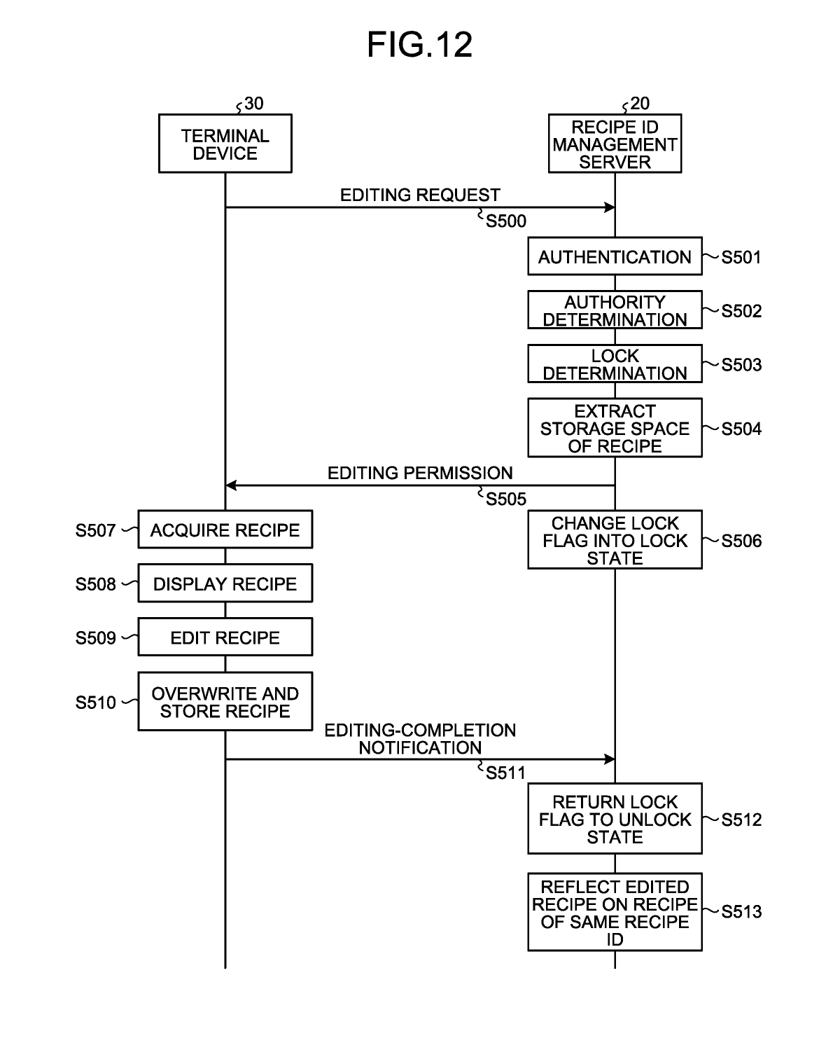

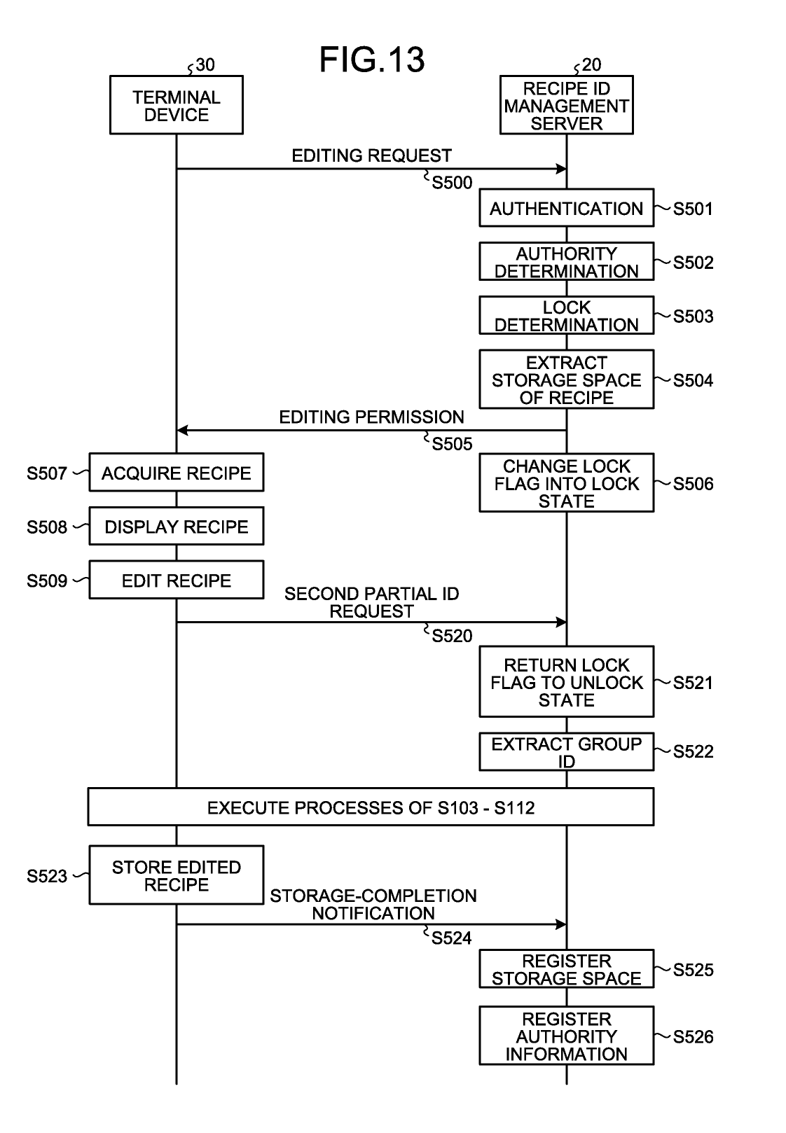

FIGS. 12 and 13 are diagrams illustrating examples of an editing process of a recipe. FIG. 12 illustrates an example of an editing process of a recipe in which an edited recipe is overwritten and stored. First, the recipe operating unit 35 of the terminal device 30 creates an editing request including the user ID and password of a user and the recipe ID of a recipe to be edited and transmits the created editing request to the recipe ID management server 20 in response to an editing directive from the user through the input device 36 (S500).

The authentication unit 204 of the recipe ID management server 20 authenticates the user of the terminal device 30 that has transmitted the editing request on the basis of the user ID and the password included in the editing request received from the terminal device 30 with reference to the user information storage unit 200 (S501). When the authentication of the user is successful, the authentication unit 204 specifies the authority information table 2011 associated with the user ID included in the editing request among the authority information tables of the authority information storage unit 201. Then, the authentication unit 204 determines whether editing of a recipe identified with the recipe ID included in the editing request is permitted with reference to the authority information in the specified authority information table 2011 (S502).

When editing of the recipe identified with the recipe ID included in the editing request is permitted, the authentication unit 204 sends, to the lock determination unit 208, the recipe ID included in the editing request and information on the terminal device 30 that has transmitted the editing request. The lock determination unit 208 performs lock determination for determining whether a value of a lock flag associated with the recipe ID received from the authentication unit 204 is a value indicating a lock state or a value indicating a unlock state with reference to the recipe ID storage unit 203 (S503). When the value of the lock flag is the value indicating a lock state, the lock determination unit 208 transmits error notification including information indicating a locked state to the terminal device 30 that has transmitted the editing request.

On the other hand, when the value of the lock flag is the value indicating a unlock state, the lock determination unit 208 sends the recipe ID received from the authentication unit 204 to the recipe management unit 209. The recipe management unit 209 extracts information indicating the storage space associated with the recipe ID received from the lock determination unit 208 from the recipe ID storage unit 203 (S504). Then, the recipe management unit 209 transmits editing permission including the extracted information indicating the storage space to the terminal device 30 that has transmitted the editing request (S505). Then, the recipe management unit 209 changes the value of the lock flag associated with the recipe ID received from the lock determination unit 208 into the value indicating a lock state with reference to the recipe ID storage unit 203 (S506).

The recipe operating unit 35 of the terminal device 30 acquires a recipe to be edited from a space specified with the information on the storage space included in the editing permission received from the recipe ID management server 20 (S507). The recipe operating unit 35 then causes the display device 37 to display the acquired recipe (S508), and starts editing the acquired recipe (S509).

Then, when editing of the recipe is terminated in response to an operation from the user through the input device 36, the recipe operating unit 35 inquires of the user the storage method of the edited recipe. In the example of FIG. 12, the recipe operating unit 35 receives the directive of the user about a method for overwriting the recipe before editing with the edited recipe. The recipe operating unit 35 overwrites with the edited recipe the recipe stored in the space specified with the information on the storage space included in the editing permission and stores the overwritten recipe (S510). Then, the recipe operating unit 35 creates editing-completion notification including the recipe ID of the edited recipe and information on the storage space of the overwritten recipe, and transmits the created editing-completion notification to the recipe ID management server 20 (S511).

The recipe management unit 209 of the recipe ID management server 20 specifies the recipe ID included in the editing-completion notification received from the terminal device 30 among the recipe IDs of the recipe ID storage unit 203. Then, the recipe management unit 209 returns the value of the lock flag associated with the specified recipe ID to the value indicating a unlock state (S512).

Next, when information on a space other than the storage space included in the editing-completion notification is included in the information on the storage space associated with the specified recipe ID, the recipe management unit 209 acquires the recipe after editing from the space specified with the information on the storage space included in the editing-completion notification. Then, the recipe management unit 209 overwrites with the acquired recipe another recipe to which the same recipe ID as the recipe ID included in the editing-completion notification is assigned and stores the overwritten recipe, and thus reflects the contents of the edited recipe on the other recipe to which the same recipe ID is assigned (S513).

FIG. 13 illustrates an example of an editing process of a recipe in which another recipe ID is assigned to an edited recipe to store it. Because the processes of Steps S500 to S509 are similar to the processes described in FIG. 12, their explanations are omitted.

When editing of the recipe is terminated in response to an operation from the user through the input device 36, the recipe operating unit 35 of the terminal device 30 inquires of the user the storage method of the edited recipe. In the example of FIG. 13, the recipe operating unit 35 receives the directive from the user about a method for assigning another recipe ID to the edited recipe to store it. The recipe operating unit 35 creates a second partial ID request including the user ID of a user and the recipe ID of a recipe before editing, and transmits the created second partial ID request to the recipe ID management server 20 (S520).

The recipe management unit 209 of the recipe ID management server 20 specifies the recipe ID included in the second partial ID request received from the terminal device 30 among the recipe IDs of the recipe ID storage unit 203. Then, the recipe management unit 209 returns the value of a lock flag associated with the specified recipe ID to a value indicating a unlock state (S521). Then, the recipe management unit 209 extracts a group ID associated with the user ID included in the second partial ID request with reference to the user information storage unit 200 (S522). Then, the recipe management unit 209 sends, to the partial ID transmission unit 205, the specified group ID and the information on the terminal device 30 that has transmitted the second partial ID request.

Then, the recipe ID management server 20 and the terminal device 30 execute the processes of Steps S103 to S112 described in FIG. 8. Then, the availability displaying unit 34 of the terminal device 30 sends, to the recipe operating unit 35, the recipe ID of which the use is permitted and which is included in the determination notification received from the recipe ID management server 20. The recipe operating unit 35 assigns the recipe ID received from the availability displaying unit 34 to the edited recipe to store the edited recipe (S523). Then, the recipe operating unit 35 creates storage-completion notification including the information indicating the storage space of the edited recipe, the recipe ID assigned to the edited recipe, and the user ID, and transmits the created storage-completion notification to the recipe ID management server 20 (S524).

The recipe management unit 209 of the recipe ID management server 20 specifies the recipe ID included in the storage-completion notification received from the terminal device 30 among the recipe IDs of the recipe ID storage unit 203. Then, the recipe management unit 209 registers the information indicating the storage space included in the storage-completion notification in the recipe ID storage unit 203 in association with the specified recipe ID (S525).

Next, the recipe management unit 209 specifies the authority information table associated with the user ID included in the storage-completion notification among the authority information tables of the authority information storage unit 201. Then, the recipe management unit 209 registers the recipe ID included in the storage-completion notification in the specified authority information table, and associates the recipe ID with authority information indicating that, for example, all operations are permitted with respect to the recipe identified with the recipe ID (S526).

[Hardware]

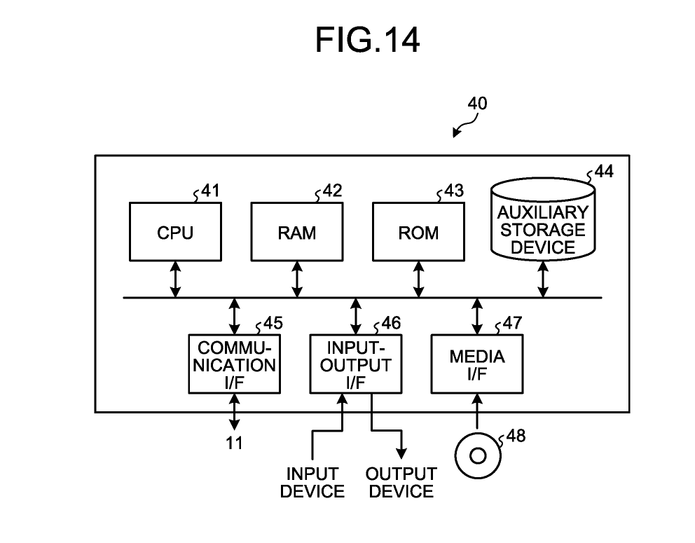

FIG. 14 is a diagram illustrating an example of a computer 40 that realizes functions of the recipe ID management server 20 or the terminal device 30. The computer 40 includes a central processing unit (CPU) 41, a random access memory (RAM) 42, a read only memory (ROM) 43, an auxiliary storage device 44, a communication interface (I/F) 45, an input-output interface (I/F) 46, and a media interface (I/F) 47.

The CPU 41 operates on the basis of programs stored in the ROM 43 or the auxiliary storage device 44 to perform the control of each component. The ROM 43 stores therein a boot program to be executed by the CPU 41 at the time of startup of the computer 40 and programs dependent on the hardware of the computer 40.

The auxiliary storage device 44 is, for example, a hard disk drive (HDD), a solid state drive (SSD), or the like, and stores therein a program to be executed by the CPU 41 and data to be used by the program. The CPU 41 reads out the program from the auxiliary storage device 44 to load the program onto the RAM 42, for example, and executes the loaded program. The communication I/F 45 receives data from other devices via the network 11 to send the data to the CPU 41, and transmits data generated by the CPU 41 to the other devices via the network 11.

The CPU 41 controls an output device such as a display and a printer and an input device such as a keyboard and a mouse via the input-output I/F 46. The CPU 41 acquires data from the input device via the input-output I/F 46. Moreover, the CPU 41 outputs the generated data to the output device via the input-output I/F 46.

The media I/F 47 reads programs or data stored in a recording medium 48 and stores the programs or data in the auxiliary storage device 44. The recording medium 48 is, for example, an optical recording medium such as a digital versatile Disc (DVD) and a phase-change rewritable disk (PD), a magneto-optical recording medium such as a magneto-optical disk (MO), a tape medium, a magnetic recording medium, a semiconductor memory, or the like.

When the computer 40 functions as the recipe ID management server 20, the CPU 41 of the computer 40 executes a program loaded on the RAM 42 to realize functions of the authentication unit 204, the partial ID transmission unit 205, the duplication determination unit 206, the availability notification unit 207, the lock determination unit 208, and the recipe management unit 209. Moreover, data in the user information storage unit 200, the authority information storage unit 201, the partial ID storage unit 202, and the recipe ID storage unit 203 are stored in the ROM 43 or the auxiliary storage device 44.

On the other hand, when the computer 40 functions as the terminal device 30, the CPU 41 of the computer 40 executes a program loaded on the RAM 42 to realize functions of the partial ID requesting unit 31, the partial ID displaying unit 32, the recipe ID creating unit 33, the availability displaying unit 34, and the recipe operating unit 35.

The CPU 41 of the computer 40 reads these programs from the recording medium 48 and stores these programs in the auxiliary storage device 44. As another example, the CPU 41 of the computer 40 may acquire these programs from another device via the network 11 and store these programs in the auxiliary storage device 44.

As described above, one embodiment has been explained. The recipe ID management system 10 according to the present embodiment can prevent the same recipe ID from being given to recipes having different contents.

The present invention is not limited to the embodiment as described above, and various modifications may be made within the scope and spirit of the inventions.

For example, in the embodiment as described above, the partial ID storage unit 202 previously stores, for each group ID, for each combination of a product and a processing step to be assigned to a user belonging to a group identified with the corresponding group ID, a partial ID included in a recipe ID of a recipe applied to the corresponding processing step. However, the disclosed technology is not limited to this. For example, the partial ID transmission unit 205 may specify information needed to specify a partial ID between users via the terminal device 30 by using conversational communication. For example, the partial ID transmission unit 205 inquires of a user a product ID of a product assigned to the user via the terminal device 30 to receive the product ID from the terminal device 30, and inquires the user a step ID of a processing step assigned to the user via the terminal device 30 to receive the product ID from the terminal device 30. Then, the partial ID transmission unit 205 may create a partial ID on the basis of the product ID and the step ID received from the terminal device 30.

In the embodiment as described above, the partial ID transmission unit 205 presents a partial ID to the user via the terminal device 30 to make the user create a recipe ID including the presented partial ID. However, the disclosed technology is not limited to this. For example, the partial ID transmission unit 205 may add a predetermined partial ID to a combination of a character, a symbol, a number, and the like optionally created by the user to create a recipe ID. Moreover, the partial ID transmission unit 205 may create candidates of some recipe IDs obtained by adding unique recipe-ID information to a partial ID and present the candidates of the created recipe IDs to the user. As a result, because the user can select a candidate from the presented recipe IDs to create a unique recipe ID including a predetermined partial ID, it is possible to reduce a burden of the user. Information to be added to a partial ID to make a unique recipe ID is, for example, a sequence number, date and time, information (user ID, group ID) of a user who requests a recipe ID, and the like.

The present invention was described in the foregoing using exemplary embodiments, but the technical scope of the present invention is not limited to that described in the foregoing exemplary embodiments. It should be clear to those skilled in the art that various modifications and alterations may be made to the foregoing embodiments. It should furthermore be clear from the scope of the appended claims that embodiments wherein such various modifications and alterations have been made are to be included within the technical scope of the present invention.

### REFERENCE SIGNS LIST

11 network
20 recipe ID management server
200 user information storage unit
201 authority information storage unit
202 partial ID storage unit
203 recipe ID storage unit
204 authentication unit
205 partial ID transmission unit
206 duplication determination unit
207 availability notification unit
208 lock determination unit
209 recipe management unit

1.-7. (canceled)

8. A recipe ID management server comprising:
a memory comprising:
one or more partial IDs being based, at least in part, on one or more recipes capable of being performed by a substrate processing apparatus; and
one or more recipe IDs being associated with one or more partial IDs; and
a processor coupled to the memory, wherein the processor is configured to execute programs loaded in the memory to:
receive a first partial ID request from a terminal device, the first partial ID request comprising a partial ID;
determine whether the first partial ID request is authorized;
determine, if the first partial ID request is authorized, which recipe ID, stored in the memory, is associated with the partial ID;
provide the recipe ID to the terminal device of the substrate processing apparatus;
receive, from the terminal device, a created recipe ID based, at least in part, on the recipe ID;
determine whether the created recipe ID is unique from the one or more recipe IDs stored in the memory;
store the created recipe ID in the memory, if the created recipe ID is unique.

9. The recipe ID management server according to claim 8, wherein the partial ID request comprises a user ID and a password.

10. The recipe ID management server according to claim 8, wherein the created recipe ID differs from the recipe ID by at least one character.

11. The recipe ID management server according to claim 8, wherein the processor is configured to execute programs loaded in the memory to provide a usage non-permission message to the terminal device when any of the partial IDs transmitted from the recipe ID management server is not included in the created recipe ID.

12. The recipe ID management server according to claim 8, wherein the processor is configured to execute programs loaded in the memory to:
provide, to the terminal device, an indication of whether the created recipe ID is unique; and
receive, from the terminal device, a created recipe notification message associated with the created recipe ID.

13. The recipe ID management server according to claim 12, wherein the processor is configured to execute programs loaded in the memory to:
receive, from the terminal device, an editing request comprising a user ID, a password, and the created recipe ID;
provide, to the terminal device, an editing permission message when the edit request is authorized based, at least in part, on authority information, stored in the memory, corresponding to at least one of the following: the user ID, the password, or the created recipe ID, and the created recipe ID is associated with a lock flag, stored in the memory, that is an unlocked state; and
change the lock flag associated with the created recipe ID to a lock state before or after the editing permission message is sent to the terminal device; and
change the lock flag associated with the created recipe ID to an unlock state when a editing completion message is received from the terminal device.

14. The recipe ID management server according to claim 13, wherein the processor is configured to execute programs loaded in the memory to:
store, in the memory, a group ID associated with the user ID, the group ID identifies a group of users authorized to edit recipes on the terminal device;
store, in the memory, the group ID in association with the one or more partial IDs;
associate, in the memory, when receiving the partial ID request from the terminal device, a group ID associated with the user ID included in the partial ID request with reference to the-memory; and
associate, in the memory, a partial ID with the specified group ID from the memory; and
transmit the partial ID with the associated group ID to the terminal device.

15. The recipe ID management server according to claim 1, wherein the partial ID includes at least one of information on a product to be manufactured by a process based on a recipe identified with a recipe ID including the partial ID and information on steps which use the recipe.

16. The recipe ID management server according to claim 8, wherein the partial ID is based, at least in part, on a product ID, a step ID, or a combination of thereof.

17. A recipe ID management system comprising:
a recipe ID management server that manages a recipe ID of identifying a recipe in which a process to be performed by a plurality of substrate processing apparatuses; and
a terminal device coupled to the recipe ID management server and to at least one substrate processing apparatus within the plurality of substrate processing apparatuses,
wherein the recipe ID management server comprises:
a first memory comprising:
one or more partial IDs being based, at least in part, on one or more recipes capable of being performed by a substrate processing apparatus; and
one or more recipe IDs being associated with one or more partial IDs; and
a first processor coupled to the first memory, wherein the first processor is configured to execute programs loaded in the memory to:
receive a first partial ID request from a terminal device, the first partial ID request comprising a partial ID, a user ID, and a password;
determine whether the first partial ID request is authorized based, at least in part, on the user ID and the password corresponding to authority information stored in the first memory;
determine, if the first partial ID request is authorized, which recipe ID, stored in the first memory, is associated with the partial ID;
provide the recipe ID to the terminal device of the substrate processing apparatus;
receive, from the terminal device, a created recipe ID based, at least in part, on the recipe ID;
determine the created recipe ID is unique from the one or more recipe IDs stored in the first memory; and
store the created recipe ID in the first memory, if the created recipe ID is unique.
wherein the terminal device comprises:
a second memory; and
a second processor coupled to the second memory, wherein the second processor is configured to execute programs loaded in the second memory to:
transmit a partial ID request to a recipe ID management server in response to a request from a user;
receive, from the recipe ID management server, a partial ID that is a part of a recipe ID associated with a recipe to be used by a substrate processing apparatus;
display the received partial ID on a display coupled to the terminal device;
generate a created recipe ID based, at least in part, on the partial ID; and
provide the created recipe ID to the recipe ID management server;
receive, from the recipe ID management server, an editing confirmation message indicating the user is authorized to edit the recipe.

18. A terminal device comprising:
a memory comprising recipe information for at least one semiconductor substrate processing apparatus; and
a processor coupled to the memory, wherein the processor is configured to execute programs loaded in the memory to:
provide a partial ID request to a recipe ID management server in response to a request from a user;
receive, from the recipe ID management server, a partial ID that is a part of a recipe ID associated with a recipe to be used by a substrate processing apparatus;
display the received partial ID on a display coupled to the terminal device;
generate a created recipe ID based, at least in part, on the partial ID;
provide the created recipe ID to the recipe ID management server; and
receive, from the recipe ID management server, an editing confirmation message indicating the user is authorized to edit the recipe.
